(19) United States
(12) Patent Application Publication
(10) Pub. No.: US 2025/0146537 A1
(43) Pub. Date: May 8, 2025

(54) TRIPOD TYPE CONSTANT VELOCITY UNIVERSAL JOINT

(71) Applicant: JTEKT CORPORATION, Kariya-shi (JP)

(72) Inventors: Kenji OISO, Aichi (JP); Akihiko HASEGAWA, Aichi (JP); Keishi KOBATA, Aichi (JP); Kenta MIZUTANI, Aichi (JP); Takuya MOTOOKA, Aichi (JP)

(73) Assignee: JTEKT CORPORATION, Kariya-shi (JP)

(21) Appl. No.: 18/834,315

(22) PCT Filed: Mar. 11, 2022
(86) PCT No.: PCT/JP2022/011094

§ 371 Date: Jul. 30, 2024

(51) Int. Cl. F16D 3/205; F16D 3/202

(52) U.S. Cl. CPC F16D 3/2055; F16D 2003/2026

(57) ABSTRACT

In a tripod type constant velocity universal joint, a groove-orthogonal sectional shape of a ceiling surface of a raceway groove of an outer ring is a line shape passing through a central highest point, a positive rotation edge highest point, and a negative rotation edge highest point. The central highest point is a point when a roller pitches by a predetermined pitching angle. The positive rotation edge highest point is a point when the roller rolls in a positive direction by a predetermined rolling angle. The negative rotation edge highest point is a point when the roller rolls in a negative direction by a predetermined rolling angle.

### TECHNICAL FIELD

The present disclosure relates to a tripod type constant velocity universal joint.

### BACKGROUND ART

A tripod type constant velocity universal joint described in Patent Document 1 is configured to suppress tilting of rollers by raceway grooves of an outer ring. Part of the ceiling surface of the raceway groove of the outer ring comes into contact with the end face of the roller, thereby suppressing tilting of the roller.

### RELATED ART DOCUMENTS

### Patent Documents

Patent Document 1: Japanese Unexamined Patent Application Publication No. 2016-130533 (JP 2016-130533 A)

### BRIEF SUMMARY

### Problem to be Solved

It is known that rollers of a tripod type constant velocity universal joint may pitch or roll as the joint operates. In the tripod type constant velocity universal joint described in Patent Document 1, however, the tilting of the roller is restricted by the ceiling surface of the raceway groove. Therefore, when the roller is to pitch or roll, friction is generated due to contact between the ceiling surface of the raceway groove of the outer ring and the end face of the roller. This friction causes a forcing power that induces vibration in the tripod type constant velocity universal joint.

The present disclosure has been made in view of such a problem, and provides a tripod type constant velocity universal joint that can suppress generation of a forcing power by preventing a roller end face from coming into contact with a ceiling surface of a raceway groove of an outer ring at least within a predetermined angle range.

### Means for Solving the Problem

One aspect of the present disclosure is a tripod type constant velocity universal joint including: an outer ring having a plurality of raceway grooves extending in an axial direction; a tripod including a plurality of tripod shaft portions extending radially outward; and rollers externally fitted onto the tripod shaft portions and configured to roll in the raceway grooves.

The raceway groove includes a first raceway surface constituting one groove side surface, a second raceway surface constituting another groove side surface, and a ceiling surface constituting a groove bottom surface.

The roller includes a roller outer circumferential surface configured to roll on the first raceway surface or the second raceway surface, and a roller end face that is an axial end face of the roller that faces the ceiling surface.

A point located on a central axis of the roller and distant from a central axis of the outer ring on a contour line obtained by projecting the roller end face in the axial direction of the outer ring when the roller pitches by a predetermined pitching angle is defined as a central highest point.

A boundary point between the roller outer circumferential surface and the roller end face that is located away from the central axis of the outer ring on a contour line obtained by projecting the roller in the axial direction of the outer ring when the roller rolls in a positive direction by a predetermined rolling angle is defined as a positive rotation edge highest point. A boundary point between the roller outer circumferential surface and the roller end face that is located away from the central axis of the outer ring on a contour line obtained by projecting the roller in the axial direction of the outer ring when the roller rolls in a negative direction by a predetermined rolling angle is defined as a negative rotation edge highest point. A groove-orthogonal sectional shape of the ceiling surface is a line shape passing through the central highest point, the positive rotation edge highest point, and the negative rotation edge highest point.

### Advantageous Effects

In the tripod type constant velocity universal joint of the above aspect, the groove-orthogonal sectional shape of the ceiling surface of the raceway groove of the outer ring is the line shape passing through the central highest point, the positive rotation edge highest point, and the negative rotation edge highest point. The central highest point is a point obtained from the contour line of the roller end face when the roller pitches by the predetermined pitching angle. The positive rotation edge highest point is a point obtained from the contour line of the roller when the roller rolls in the positive direction by the predetermined rolling angle. The negative rotation edge highest point is a point obtained from the contour line of the roller when the roller rolls in the negative direction by the predetermined rolling angle.

Therefore, the roller can be prevented from coming into contact with the ceiling surface of the raceway groove of the outer ring when the roller pitches by an angle smaller than the predetermined pitching angle and rolls by an angle smaller than the predetermined rolling angle. In this way, the roller end face can be prevented from coming into contact with the ceiling surface of the raceway groove of the outer ring when the roller pitches and rolls at least within the predetermined angle ranges. Thus, the generation of the forcing power can be suppressed.

In particular, the central highest point is a point located on the central axis of the roller and distant from the central axis of the outer ring on the contour line obtained by projecting the roller end face in the axial direction of the outer ring when the roller pitches by the predetermined pitching angle. The positive rotation edge highest point is a boundary point between the roller outer circumferential surface and the roller end face that is located away from the central axis of the outer ring on the contour line obtained by projecting the roller in the axial direction of the outer ring when the roller rolls in the positive direction by the predetermined rolling angle. The negative rotation edge highest point is a boundary point between the roller outer circumferential surface and the roller end face that is located away from the central axis of the outer ring on the contour line obtained by projecting the roller in the axial direction of the outer ring when the roller rolls in the negative direction by the predetermined rolling angle.

In this way, the shape of the ceiling surface is defined in consideration of which positions on the groove-orthogonal sectional shape of the ceiling surface approach which points on the roller during both the pitching and the rolling. With this configuration, the roller end face can be prevented from coming into contact with the ceiling surface of the raceway groove of the outer ring when the roller pitches and rolls at least within the predetermined angle ranges. Thus, the generation of the forcing power can be suppressed.

As described above, according to the above aspect, it is possible to provide the tripod type constant velocity universal joint that can suppress the generation of the forcing power by preventing the roller end face from coming into contact with the ceiling surface of the raceway groove of the outer ring at least within the predetermined angle range.

Reference signs in parentheses in the claims represent the corresponding relationships with specific means described in embodiments described later, and are not intended to limit the technical scope of the present disclosure.

### BRIEF DESCRIPTION OF THE DRAWINGS

FIG. 1 is a diagram of a tripod type constant velocity universal joint of a first embodiment as viewed in an axial direction, showing a case where a joint angle is 0° and showing only a portion of one raceway groove of an outer ring.

FIG. 2 is a sectional view taken along line II-II in FIG. 1, and is an axial partial sectional view of the tripod type constant velocity universal joint.

FIG. 3 is a sectional view taken along line III-III in FIG. 2, and is a radial partial sectional view of the tripod type constant velocity universal joint.

FIG. 4 is a partial view of the tripod type constant velocity universal joint as viewed in the axial direction when the joint angle is θp1 and a roller pitches by a pitching angle θp1.

FIG. 5 is a sectional view taken along line V-V in FIG. 4, and is an axial partial sectional view of the tripod type constant velocity universal joint when the joint angle is θpT.

FIG. 6 is a partial view of the tripod type constant velocity universal joint as viewed in the axial direction when the joint angle is 0° and the roller rolls in a positive direction by a rolling angle θr1.

FIG. 7 is a partial view of the tripod type constant velocity universal joint as viewed in the axial direction when the joint angle is 0° and the roller rolls in a negative direction by a rolling angle θr2.

FIG. 8 is an axial partial sectional view of the tripod type constant velocity universal joint when the joint angle is θp2 and the roller pitches by a pitching angle θp2.

FIG. 9 is a diagram showing only the outer ring and the roller as viewed from a left side of FIG. 7, that is, in the axial direction of the outer ring.

FIG. 10 is a partial view of the tripod type constant velocity universal joint as viewed in the axial direction when the joint angle is 0° and the roller rolls in the positive direction by a rolling angle θr11.

FIG. 11 is a partial view of the tripod type constant velocity universal joint as viewed in the axial direction when the joint angle is 0° and the roller rolls in the negative direction by a rolling angle θr12.

FIG. 12 is a diagram showing a groove-orthogonal sectional shape of a ceiling surface of the raceway groove of the outer ring.

FIG. 13 is a partial view of a tripod type constant velocity universal joint of a second embodiment as viewed in the axial direction when the roller pitches by the pitching angle θp2 and comes into contact with a first raceway surface.

FIG. 14 is a partial view of the tripod type constant velocity universal joint of the second embodiment as viewed in the axial direction when the roller pitches by the pitching angle θp2 and comes into contact with a second raceway surface.

FIG. 15 is a partial view of the tripod type constant velocity universal Joint as viewed in the axial direction when the joint angle is 0° and the roller rolls in the positive direction by the rolling angle θr11 and comes into contact with the first raceway surface.

FIG. 16 is a partial view of the tripod type constant velocity universal joint as viewed in the axial direction when the joint angle is 0° and the roller rolls in the negative direction by the rolling angle θr12 and comes into contact with the second raceway surface.

FIG. 17 is a diagram showing the groove-orthogonal sectional shape of the ceiling surface of the raceway groove of the outer ring.

FIG. 18 is a partial view of a tripod type constant velocity universal joint of a third embodiment as viewed in the axial direction when the joint angle is 0° and the roller rolls in the positive direction by the rolling angle θr11 and comes into contact with the second raceway surface.

FIG. 19 is a partial view of the tripod type constant velocity universal joint of the third embodiment as viewed in the axial direction when the joint angle is 0° and the roller rolls in the negative direction by the rolling angle θr12 and comes into contact with the first raceway surface.

FIG. 20 is a diagram showing the groove-orthogonal sectional shape of the ceiling surface of the raceway groove of the outer ring.

FIG. 21 is a diagram showing a groove-orthogonal sectional shape of a ceiling surface of a raceway groove of an outer ring of a tripod type constant velocity universal joint of a fourth embodiment.

### MODES FOR CARRYING OUT

### First Embodiment

### 1. Configuration of Tripod Type Constant Velocity Universal Joint 1

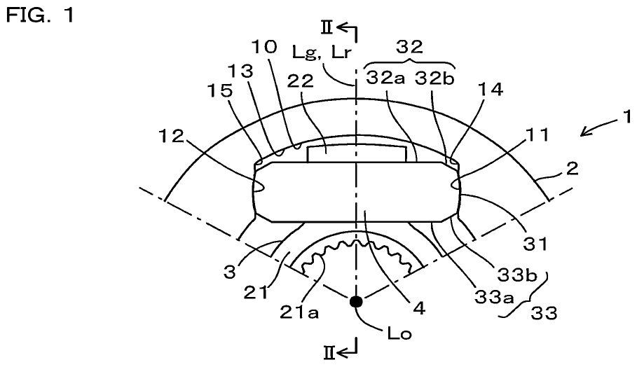

The configuration of a tripod type constant velocity universal joint 1 of the present embodiment will be described with reference to FIGS. 1 to 3. The tripod type constant velocity universal joint 1 is used, for example, in a drive shaft or a propeller shaft of a vehicle. The tripod type constant velocity universal Joint 1 includes an outer ring 2, a tripod 3, and rollers 4.

The outer ring 2 is formed in a tubular shape with a bottom, and has three raceway grooves 10 extending in an axial direction on its inner circumferential surface. The three raceway grooves 10 are positioned at equal intervals in a circumferential direction. FIGS. 1 to 3 show only one raceway groove 10. In the following description, a groove-orthogonal cross section is a cross section orthogonal to the direction in which the raceway groove 10 extends, and a groove-direction cross section is a cross section in the direction in which the raceway groove 10 extends. A line that is orthogonal to a central axis Lo of the outer ring 2 and passes through the center of the raceway groove 10 in a groove width direction is defined as a raceway groove center line Lg.

The raceway groove 10 includes a first raceway surface 11 constituting one groove side surface, and a second raceway surface 12 constituting the other groove side surface. The first raceway surface 11 and the second raceway surface 12 face each other. The groove-orthogonal sectional shape of each of the first raceway surface 11 and the second raceway surface 12 is a curved concave shape in the groove-orthogonal cross section of the raceway groove 10. The groove-orthogonal sectional shape of each of the first raceway surface 11 and the second raceway surface 12 is, for example, a Gothic arc shape in which two circular arcs are connected.

The raceway groove 10 further includes a ceiling surface 13 constituting a groove bottom surface. The detailed shape of the ceiling surface 13 will be described later. In the present embodiment, the raceway groove 10 includes a first recessed surface 14 and a second recessed surface 15. The first recessed surface 14 is a portion connecting the first raceway surface 11 and the ceiling surface 13, and is positioned at one groove bottom corner portion. The second recessed surface 15 is a portion connecting the second raceway surface 12 and the ceiling surface 13, and is positioned at the other groove bottom corner portion. The groove-orthogonal sectional shape of each of the first recessed surface 14 and the second recessed surface 15 is a curved concave shape having a smaller radius of curvature than those of the first raceway surface 11, the second raceway surface 12, and the ceiling surface 13.

The tripod 3 is a member attached to a shaft that is not shown, and constitutes an inner member housed in the outer ring 2. The tripod 3 includes a boss portion 21 and three tripod shaft portions 22. The boss portion 21 is formed in a tubular shape, and includes a spline formed on its inner circumferential surface so that it can be fitted to the shaft.

The tripod shaft portion 22 is a shaft member extending radially outward from the outer circumferential surface of the boss portion 21. The tripod shaft portion 22 is formed in a columnar shape, a spherical shape, etc. For example, the tripod shaft portion 22 formed in the columnar shape may have a circular columnar shape, an elliptical columnar shape, or a composite columnar shape in which part of a circular column or an elliptical column is formed into a planar shape. In the present embodiment, the column sectional shape of the tripod shaft portion 22 includes a pair of convex curved portions constituting an ellipse, and straight portions connecting the convex curved portions.

The roller 4 is externally fitted onto the tripod shaft portion 22, and is slidable in the axial direction of the tripod shaft portion 22. The roller 4 rolls in the raceway groove 10 of the outer ring 2 while being externally fitted onto the tripod shaft portion 22. When transmitting torque between the roller 4 and the first raceway surface 11, the roller 4 rolls on the first raceway surface 11. When transmitting torque between the roller 4 and the second raceway surface 12, the roller 4 rolls on the second raceway surface 12.

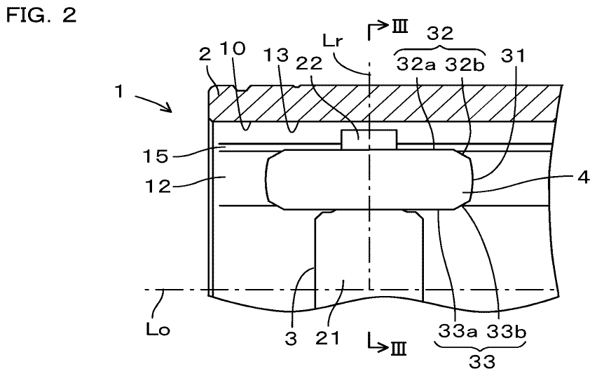

As shown in FIGS. 1 and 2, the outer shape of the roller 4 includes a roller outer circumferential surface 31, a roller end face 32, and a roller base surface 33. The roller outer circumferential surface 31 is configured to roll on the first raceway surface 11 or the second raceway surface 12. The roller outer circumferential surface 31 is formed, for example, in a spherical shape centered on a point on a central axis Lr of the roller 4.

The roller end face 32 is one of the axial end faces of the roller 4 that faces the ceiling surface 13. In the present embodiment, the roller end face 32 includes a circular flat portion 32a and a chamfered portion 32b. The circular flat portion 32a is formed in a disc shape centered on the central axis Lr of the roller 4 and parallel to a plane orthogonal to the axis of the roller 4. The chamfered portion 32b is a surface connecting the outer circumferential edge of the circular flat portion 32a and the roller outer circumferential surface 31, and is formed in a partial conical shape inclined with respect to the plane orthogonal to the axis of the roller 4.

The roller base surface 33 is one of the axial end faces of the roller 4 that is opposite to the roller end face 32. In the present embodiment, the roller base surface 33 is formed in a plane symmetrical shape to the roller end face 32. The roller base surface 33 includes a circular flat portion 33a and a chamfered portion 33b. The circular flat portion 33a is formed in a disc shape centered on the central axis Lr of the roller 4 and parallel to the plane orthogonal to the axis of the roller 4. The chamfered portion 33b is a surface connecting the outer circumferential edge of the circular flat portion 33a and the roller outer circumferential surface 31, and is formed in a partial conical shape inclined with respect to the plane orthogonal to the axis of the roller 4.

The roller 4 may be of either a single roller type or a double roller type. For example, the roller 4 of the single roller type includes an outer roller and a plurality of needle bearings arranged between the outer circumferential surface of the tripod shaft portion 22 and the inner circumferential surface of the outer roller. The roller 4 of the double roller type includes an outer roller, an inner roller, and a plurality of needle bearings arranged between the outer roller and the inner roller. The roller 4 may be tiltable or non-tiltable relative to the tripod shaft portion 22.

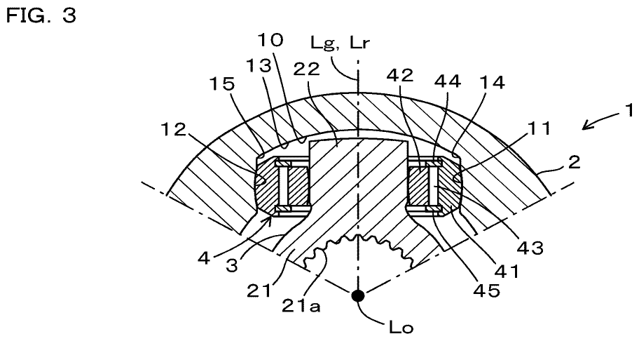

In the present embodiment, the roller 4 is of the double roller type as shown in FIG. 3. The roller 4 includes an outer roller 41, an inner roller 42, a plurality of needle bearings 43, and snap rings 44, 45. The outer circumferential surface of the outer roller 41 is configured to roll on the first raceway surface 11 and the second raceway surface 12.

The axial sectional shape of the inner circumferential surface of the inner roller 42 is, for example, a curved shape that is convex radially inward. The inner roller 42 is externally fitted onto the outer circumferential surface of the tripod shaft portion 22, and is tiltable relative to the tripod shaft portion 22. The plurality of needle bearings 43 is interposed between the inner circumferential surface of the outer roller 41 and the outer circumferential surface of the inner roller 42. The snap rings 44, 45 are latched to the outer roller 41, and engage with the inner roller 42 and the plurality of needle bearings 43 to position the inner roller 42 and the plurality of needle bearings 43.

### 2. Operation of Tripod Type Constant Velocity Universal Joint 1

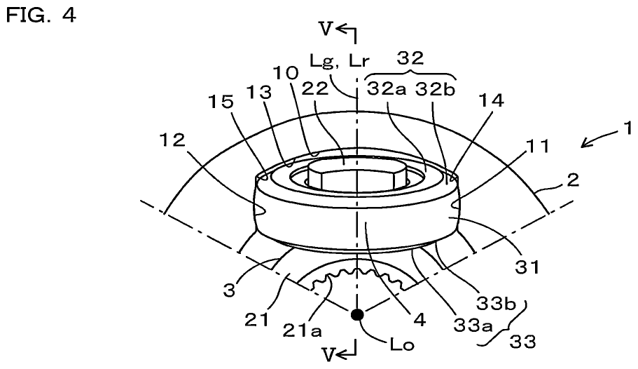

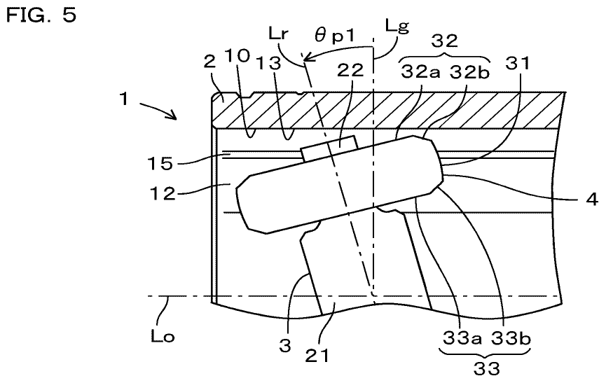

The operation of the tripod type constant velocity universal joint 1 will be described with reference to FIGS. 4 to 7. As shown in FIGS. 4 and 5, the angle between the central axis Lo of the outer ring 2 and the central axis of the tripod 3 is a joint angle. When the central axis Lr of the roller 4 agrees with the central axis of the tripod shaft portion 22, the angle between the raceway groove center line Lg and the central axis Lr of the roller 4 is equal to the joint angle. FIGS. 4 and 5 show a state in which the joint angle is θp1.

When the joint angle is θp1 and the tripod type constant velocity universal joint 1 rotates, torque is transmitted between the outer ring 2 and the tripod 3 via the roller 4. At this time, the roller 4 rolls on the first raceway surface 11 or the second raceway surface 12 and moves back and forth in the raceway groove 10 while pitching relative to the raceway groove 10.

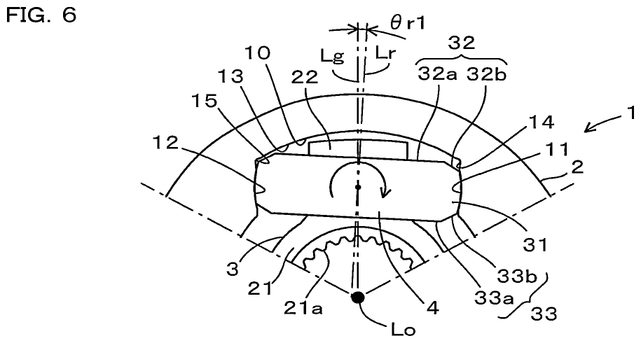

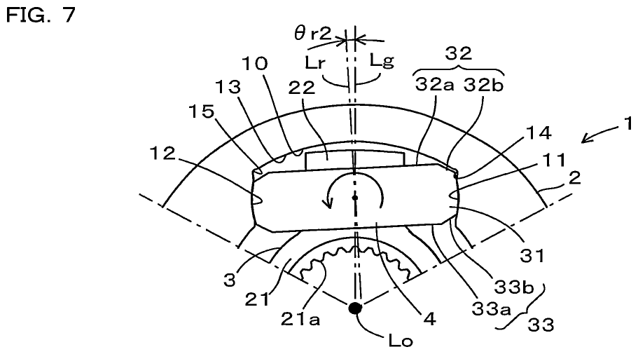

Further, the position on the tripod shaft portion 22 that comes into contact with the roller 4 is shifted in the axial direction of the tripod shaft portion 22. Therefore, the roller 4 rolls in a positive direction as shown in FIG. 6 or rolls in a negative direction as shown in FIG. 7. In FIG. 6, the rolling angle of the rolling in the positive direction is θr1. In FIG. 7, the rolling angle of the rolling in the negative direction is θr2. The rolling angle θr1 is an angle between the raceway groove center line Lg and the central axis Lr of the roller 4 during the rolling in the positive direction. The rolling angle θr2 is an angle between the raceway groove center line Lg and the central axis Lr of the roller 4 during the rolling in the negative direction.

A maximum joint angle φ1 of the tripod type constant velocity universal joint 1 during straightforward traveling of the vehicle at a constant speed is an angle included in a range of, for example, 4 to 10°. A maximum joint angle φ2 of the tripod type constant velocity universal joint 1 during acceleration or deceleration of the vehicle traveling straightforward can have an angle range larger than that of the maximum joint angle φ1. The maximum joint angle φ2 is included in a range of, for example, 6 to 20°. A maximum joint angle φ3 of the tripod type constant velocity universal Joint 1 during maximum steering can have an angle range larger than those of the maximum joint angles φ1, φ2. The maximum joint angle φ3 is included in a range of, for example, 10 to 25°.

A maximum rolling angle φ11 of the roller 4 during straightforward traveling of the vehicle at a constant speed is an angle included in a range of, for example, 0 to 5°. A maximum rolling angle φ12 of the roller 4 during acceleration or deceleration of the vehicle traveling straightforward is included in a range of, for example, 0 to 5°. A maximum rolling angle φ13 of the roller 4 during maximum steering can have an angle range larger than those of the maximum rolling angles φ11, φ12. The maximum rolling angle φ13 is included in a range of, for example, 0 to 10°.

### 3. Outline of Groove-Orthogonal Sectional Shape of Ceiling Surface 13

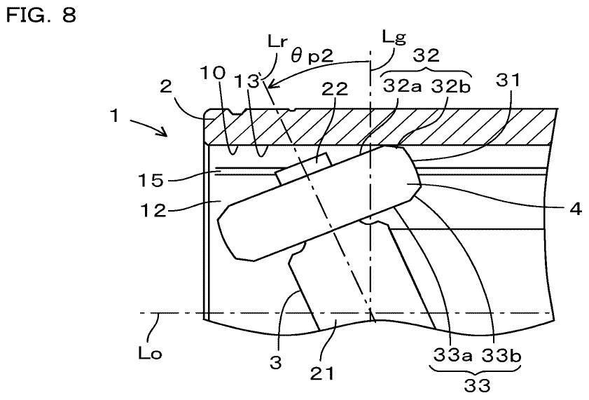

The outline of the groove-orthogonal sectional shape of the ceiling surface 13 of the raceway groove 10 of the outer ring 2 will be described with reference to FIGS. 8 to 11. The groove-orthogonal sectional shape of the ceiling surface 13 is determined using the shape of the roller 4 when the roller 4 pitches by a predetermined pitching angle θp2 as shown in FIG. 8. When the roller 4 pitches by the predetermined pitching angle θp2, the roller 4 appears as shown in FIG. 7 as viewed in the axial direction of the outer ring 2. The predetermined pitching angle θp2 is a contact pitching angle. This means that the roller 4 can come into contact with the ceiling surface 13 when the roller 4 pitches by the predetermined angle θp2.

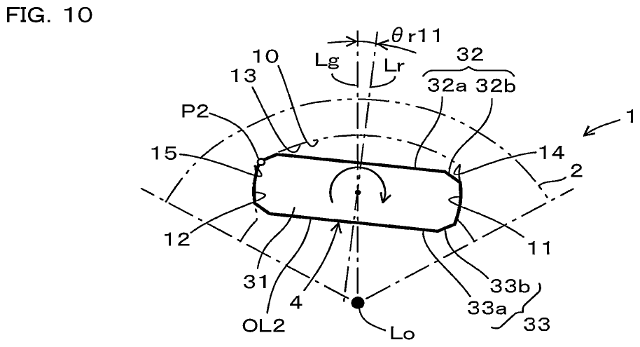

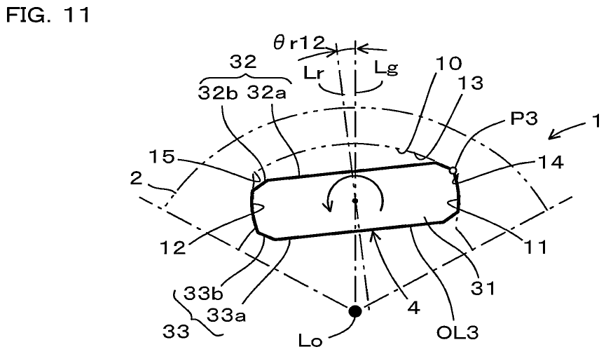

Further, the groove-orthogonal sectional shape of the ceiling surface 13 is determined using the shape of the roller 4 when the roller 4 rolls in the positive direction by a predetermined rolling angle θr11 as shown in FIG. 10. The groove-orthogonal sectional shape of the ceiling surface 13 is determined using the shape of the roller 4 when the roller 4 rolls in the negative direction by a predetermined rolling angle θr12 as shown in FIG. 11. The predetermined rolling angles θr11, θr12 are contact rolling angles. This means that the roller 4 can come into contact with the ceiling surface 13 when the roller 4 rolls in the positive direction by the predetermined rolling angle θr11 or when the roller 4 rolls in the negative direction by the predetermined rolling angle θr12. The rolling angle θr11 is an angle between the raceway groove center line Lg and the central axis Lr of the roller 4 during the rolling in the positive direction. The rolling angle θr12 is an angle between the raceway groove center line Lg and the central axis Lr of the roller 4 during the rolling in the negative direction.

The predetermined pitching angle θp2 can be one of the following two types of angle. A first predetermined pitching angle θp2 is set to an angle larger than the maximum joint angle φ1 during straightforward traveling of the vehicle at a constant speed and equal to or smaller than the maximum joint angle φ2 during acceleration or deceleration of the vehicle traveling straightforward. In this case, the first predetermined pitching angle θp2 is naturally an angle smaller than the maximum joint angle φ3 during maximum steering.

In this case, the roller 4 does not come into contact with the ceiling surface 13 when the pitching angle of the roller 4 is the maximum joint angle φ1 during straightforward traveling of the vehicle at a constant speed. The roller 4 comes into contact with the ceiling surface 13 when the pitching angle of the roller 4 is the maximum joint angle φ2 during acceleration or deceleration of the vehicle traveling straightforward. When the pitching angle of the roller 4 is changing to increase, the roller 4 comes into contact with the ceiling surface 13 within the range in which the pitching angle of the roller 4 is larger than φ1 and equal to or smaller than φ2.

A second predetermined pitching angle θp2 is set to an angle larger than the maximum joint angle φ2 during acceleration or deceleration of the vehicle traveling straightforward and equal to or smaller than the maximum joint angle φ3 during maximum steering. In this case, the second predetermined pitching angle θp2 is naturally an angle larger than the maximum joint angle φ1 during straightforward traveling of the vehicle at a constant speed.

In this case, the roller 4 does not come into contact with the ceiling surface 13 when the pitching angle of the roller 4 is the maximum joint angle φ1 during straightforward traveling of the vehicle at a constant speed. Further, the roller 4 does not come into contact with the ceiling surface 13 when the pitching angle of the roller 4 is the maximum joint angle φ2 during acceleration or deceleration of the vehicle traveling straightforward. The roller 4 comes into contact with the ceiling surface 13 when the pitching angle of the roller 4 is the maximum joint angle φ3 during maximum steering. When the pitching angle of the roller 4 is changing to increase, the roller 4 comes into contact with the ceiling surface 13 within the range in which the pitching angle of the roller 4 is larger than φ2 and equal to or smaller than φ3.

Since the predetermined rolling angles θr11, θr12 are associated with the predetermined pitching angle θp2, the predetermined rolling angles θr11, θr12 can be one of the following two types of angle similarly to the predetermined pitching angle θp2. First predetermined rolling angles θr11, θr12 are set to angles larger than the maximum rolling angle φ11 during straightforward traveling of the vehicle at a constant speed and equal to or smaller than the maximum rolling angle φ12 during acceleration or deceleration of the vehicle traveling straightforward. In this case, the first predetermined rolling angles θr11, θr12 are naturally angles smaller than the maximum rolling angle φ13 during maximum steering.

In this case, the roller 4 does not come into contact with the ceiling surface 13 when the rolling angle of the roller 4 is the maximum rolling angle φ11 during straightforward traveling of the vehicle at a constant speed. The roller 4 comes into contact with the ceiling surface 13 when the rolling angle of the roller 4 is the maximum rolling angle φ12 during acceleration or deceleration of the vehicle traveling straightforward. When the rolling angle of the roller 4 is changing to increase, the roller 4 comes into contact with the ceiling surface 13 within the range in which the rolling angle of the roller 4 is larger than p11 and equal to or smaller than p12.

Second predetermined rolling angles θr11, θr12 are set to angles larger than the maximum rolling angle φ12 during acceleration or deceleration of the vehicle traveling straightforward and equal to or smaller than the maximum rolling angle φ13 during maximum steering. In this case, the second predetermined rolling angles θr11, θr12 are naturally angles larger than the maximum rolling angle φ11 during straightforward traveling of the vehicle at a constant speed.

In this case, the roller 4 does not come into contact with the ceiling surface 13 when the rolling angle of the roller 4 is the maximum rolling angle φ11 during straightforward traveling of the vehicle at a constant speed. Further, the roller 4 does not come into contact with the ceiling surface 13 when the rolling angle of the roller 4 is the maximum rolling angle φ12 during acceleration or deceleration of the vehicle traveling straightforward. The roller 4 comes into contact with the ceiling surface 13 when the rolling angle of the roller 4 is the maximum rolling angle φ13 during maximum steering. When the rolling angle of the roller 4 is changing to increase, the roller 4 comes into contact with the ceiling surface 13 within the range in which the rolling angle of the roller 4 is larger than φ12 and equal to or smaller than φ13.

When the roller 4 is not in contact with the ceiling surface 13, a clearance is present between the roller 4 and the ceiling surface 13. Therefore, as the range of the pitching angle at which the roller 4 is not in contact with the ceiling surface 13 increases, the generation of a forcing power can be suppressed more in the range in which the roller 4 reaches a large pitching angle. Similarly, as the range of the rolling angle at which the roller 4 is not in contact with the ceiling surface 13 increases, the generation of the forcing power can be suppressed more in the range in which the roller 4 reaches a large rolling angle.

As the pitching angle at which the roller 4 is not in contact with the ceiling surface 13 increases, the size of the outer ring 2 increases. Similarly, as the rolling angle at which the roller 4 is not in contact with the ceiling surface 13 increases, the size of the outer ring 2 increases. Therefore, the ranges of the pitching angle and the rolling angle at which the roller 4 is not in contact with the ceiling surface 13 are not increased excessively and the range in which the generation of the forcing power can be suppressed is minimized. Thus, the effects of downsizing and suppression of the forcing power can be attained.

### 4. Details of Groove-Orthogonal Sectional Shape of Ceiling Surface 13

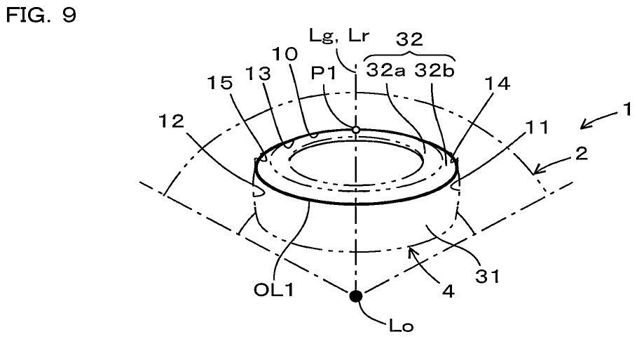

Details of the groove-orthogonal sectional shape of the ceiling surface 13 will be described with reference to FIGS. 9 to 11. As shown in FIG. 9, a contour line OL1 obtained by projecting the roller end face 32 in the axial direction of the outer ring 2 when the roller 4 pitches by the predetermined pitching angle θp2 has a shape indicated by a wide continuous line. At this time, the roller 4 does not roll. In the present embodiment, part of the contour line OL1 is defined by a boundary line between the circular flat portion 32a and the chamfered portion 32b, and the other part of the contour line OL1 is defined by a boundary line between the chamfered portion 32b and the roller outer circumferential surface 31. A point on the contour line OL1 that is located on the central axis Lr of the roller 4 and is distant from the central axis Lo of the outer ring 2 is defined as a central highest point P1.

As shown in FIG. 10, a contour line OL2 obtained by projecting the roller 4 in the axial direction of the outer ring 2 when the joint angle is 0° and the roller 4 rolls in the positive direction by the predetermined rolling angle θr11 has a shape indicated by a wide continuous line. Therefore, the contour line OL2 is formed by the roller outer circumferential surface 31, the roller end face 32, and the roller base surface 33. A boundary point on the contour line OL2 between the roller outer circumferential surface 31 and the roller end face 32 that is located away from the central axis Lo of the outer ring 2 is defined as a positive rotation edge highest point P2.

As shown in FIG. 11, a contour line OL3 obtained by projecting the roller 4 in the axial direction of the outer ring 2 when the joint angle is 0° and the roller 4 rolls in the negative direction by the predetermined rolling angle θr12 has a shape indicated by a wide continuous line. Therefore, the contour line OL3 is formed by the roller outer circumferential surface 31, the roller end face 32, and the roller base surface 33. A boundary point on the contour line OL3 between the roller outer circumferential surface 31 and the roller end face 32 that is located away from the central axis Lo of the outer ring 2 is defined as a negative rotation edge highest point P3.

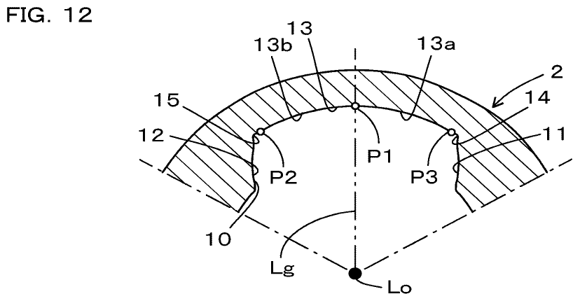

As shown in FIG. 12, the groove-orthogonal sectional shape of the ceiling surface 13 is a line shape passing through the central highest point P1, the positive rotation edge highest point P2, and the negative rotation edge highest point P3. Specifically, the groove-orthogonal sectional shape of the ceiling surface 13 is defined by a curved shape 13a connecting the central highest point P1 and the positive rotation edge highest point P2, and a curved shape 13b connecting the central highest point P1 and the negative rotation edge highest point P3. Each of the curved shapes 13a, 13b may be defined by an ellipse or a circular arc.

### 5. Effects

In the tripod type constant velocity universal joint 1 of the present embodiment, the groove-orthogonal sectional shape of the ceiling surface 13 of the raceway groove 10 of the outer ring 2 is the line shape passing through the central highest point P1, the positive rotation edge highest point P2, and the negative rotation edge highest point P3. The central highest point P1 is a point obtained from the contour line OL1 of the roller end face 32 when the roller 4 pitches by the predetermined pitching angle θp2. The positive rotation edge highest point P2 is a point obtained from the contour line OL2 of the roller 4 when the roller 4 rolls in the positive direction by the predetermined rolling angle θr11. The negative rotation edge highest point P3 is a point obtained from the contour line OL3 of the roller 4 when the roller 4 rolls in the negative direction by the predetermined rolling angle θr12.

Therefore, the roller 4 can be prevented from coming into contact with the ceiling surface 13 of the raceway groove 10 of the outer ring 2 when the roller 4 pitches by an angle smaller than the predetermined pitching angle θp2 and rolls by an angle smaller than the predetermined rolling angles θr11, θr12. In this way, the roller end face 32 can be prevented from coming into contact with the ceiling surface 13 of the raceway groove 10 of the outer ring 2 when the roller 4 pitches and rolls at least within the predetermined angle ranges. Thus, the generation of the forcing power can be suppressed.

In particular, the central highest point P1 is a point located on the central axis Lr of the roller 4 and distant from the central axis Lo of the outer ring 2 on the contour line OL1 obtained by projecting the roller end face 32 in the axial direction of the outer ring 2 when the roller 4 pitches by the predetermined pitching angle θp2. The positive rotation edge highest point P2 is a boundary point between the roller outer circumferential surface 31 and the roller end face 32 that is located away from the central axis Lo of the outer ring 2 on the contour line OL2 obtained by projecting the roller 4 in the axial direction of the outer ring 2 when the roller 4 rolls in the positive direction by the predetermined rolling angle θr11. The negative rotation edge highest point P3 is a boundary point between the roller outer circumferential surface 31 and the roller end face 32 that is located away from the central axis Lo of the outer ring 2 on the contour line OL3 obtained by projecting the roller 4 in the axial direction of the outer ring 2 when the roller 4 rolls in the negative direction by the predetermined rolling angle θr12.

In this way, the shape of the ceiling surface 13 is defined in consideration of which positions on the groove-orthogonal sectional shape of the ceiling surface 13 approach which points on the roller 4 during both the pitching and the rolling. With this configuration, the roller end face 32 can be prevented from coming into contact with the ceiling surface 13 of the raceway groove 10 of the outer ring 2 when the roller 4 pitches and rolls at least within the predetermined angle ranges. Thus, the generation of the forcing power can be suppressed.

### Second Embodiment

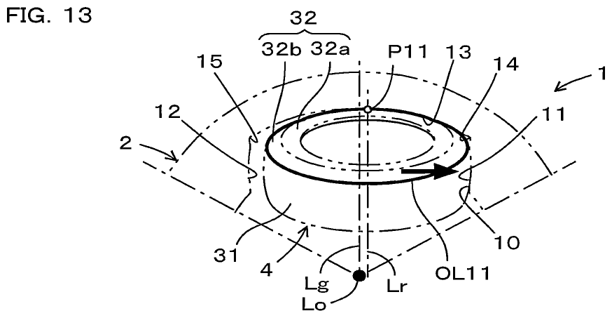

The groove-orthogonal sectional shape of a ceiling surface 13 of a tripod type constant velocity universal joint 1 of a second embodiment will be described with reference to FIGS. 13 to 17. For ease of the description, the difference between the facing distance between the first raceway surface 11 and the second raceway surface 12 and the width of the roller outer circumferential surface 31 is exaggerated in FIGS. 13 to 17. In actuality, the difference between the facing distance between the first raceway surface 11 and the second raceway surface 12 and the width of the roller outer circumferential surface 31 is very small.

In FIG. 13, it is assumed that torque is transmitted between the roller 4 and the first raceway surface 11. A contour line OL11 obtained by projecting the roller end face 32 in the axial direction of the outer ring 2 when the roller 4 pitches by the predetermined pitching angle θp2 and the roller outer circumferential surface 31 comes into contact with the first raceway surface 11 and has a clearance from the second raceway surface 12 has a shape indicated by a wide continuous line. At this time, the roller 4 does not roll. In the present embodiment, part of the contour line OL11 is defined by a boundary line between the circular flat portion 32a and the chamfered portion 32b, and the other part of the contour line OL11 is defined by a boundary line between the chamfered portion 32b and the roller outer circumferential surface 31. A point on the contour line OL11 that is located on the central axis Lr of the roller 4 and is distant from the central axis Lo of the outer ring 2 is defined as a first central highest point P11.

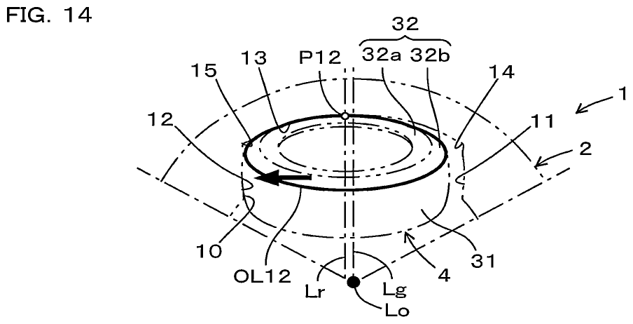

In FIG. 14, it is assumed that torque is transmitted between the roller 4 and the second raceway surface 12. A contour line OL12 obtained by projecting the roller end face 32 in the axial direction of the outer ring 2 when the roller 4 pitches by the predetermined pitching angle θp2 and the roller outer circumferential surface 31 comes into contact with the second raceway surface 12 and has a clearance from the first raceway surface 11 has a shape indicated by a wide continuous line. At this time, the roller 4 does not roll. In the present embodiment, part of the contour line OL12 is defined by a boundary line between the circular flat portion 32a and the chamfered portion 32b, and the other part of the contour line OL12 is defined by a boundary line between the chamfered portion 32b and the roller outer circumferential surface 31. A point on the contour line OL12 that is located on the central axis Lr of the roller 4 and is distant from the central axis Lo of the outer ring 2 is defined as a second central highest point P12.

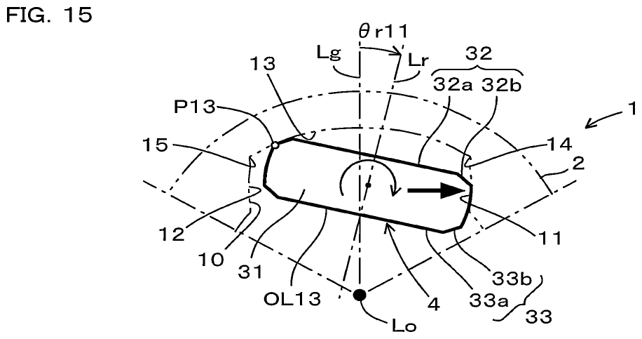

As shown in FIG. 15, a contour line OL13 obtained by projecting the roller 4 in the axial direction of the outer ring 2 when the joint angle is 0°, the roller 4 rolls in the positive direction by the predetermined rolling angle θr11, and the roller outer circumferential surface 31 comes into contact with the first raceway surface 11 and has a clearance from the second raceway surface 12 has a shape indicated by a wide continuous line. Therefore, the contour line OL13 is formed by the roller outer circumferential surface 31, the roller end face 32, and the roller base surface 33. A boundary point on the contour line OL13 between the roller outer circumferential surface 31 and the roller end face 32 that is located away from the central axis Lo of the outer ring 2 is defined as a positive rotation back side edge highest point P13.

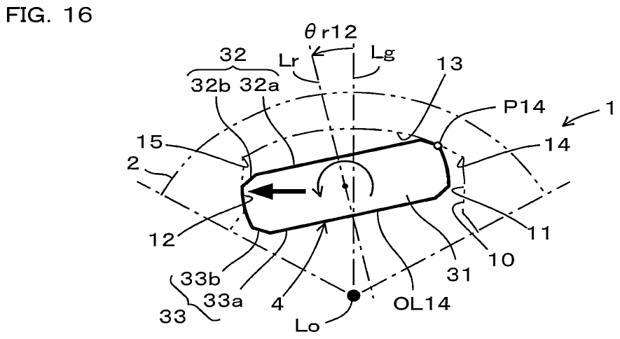

As shown in FIG. 16, a contour line OL14 obtained by projecting the roller 4 in the axial direction of the outer ring 2 when the joint angle is 0°, the roller 4 rolls in the negative direction by the predetermined rolling angle θr12, and the roller outer circumferential surface 31 comes into contact with the second raceway surface 12 and has a clearance from the first raceway surface 11 has a shape indicated by a wide continuous line. Therefore, the contour line OL14 is formed by the roller outer circumferential surface 31, the roller end face 32, and the roller base surface 33. A boundary point on the contour line OL14 between the roller outer circumferential surface 31 and the roller end face 32 that is located away from the central axis Lo of the outer ring 2 is defined as a negative rotation back side edge highest point P14.

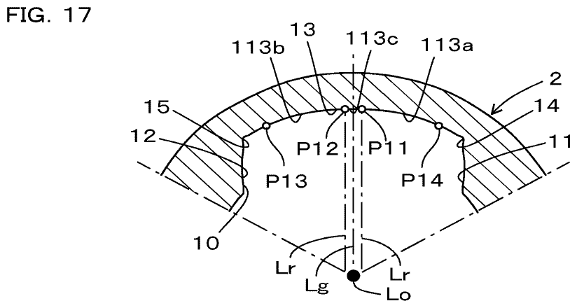

As shown in FIG. 17, the groove-orthogonal sectional shape of the ceiling surface 13 is a line shape passing through the first central highest point P11, the second central highest point P12, the positive rotation back side edge highest point P13, and the negative rotation back side edge highest point P14. Specifically, the groove-orthogonal sectional shape of the ceiling surface 13 is defined by a curved shape 113a connecting the first central highest point P11 and the negative rotation back side edge highest point P14, a curved shape 113b connecting the second central highest point P12 and the positive rotation back side edge highest point P13, and a straight shape 113c connecting the first central highest point P11 and the second central highest point P12. Each of the curved shapes 113a, 113b may be defined by an ellipse or a circular arc.

According to the present embodiment, when the roller outer circumferential surface 31 is in contact with one of the first raceway surface 11 and the second raceway surface 12 and has a clearance from the other, the groove-orthogonal sectional shape of the ceiling surface 13 can be set to a shape in consideration of the clearance. Thus, it is possible to reduce the size and weight of the outer ring 2 in consideration of the clearance.

### Third Embodiment

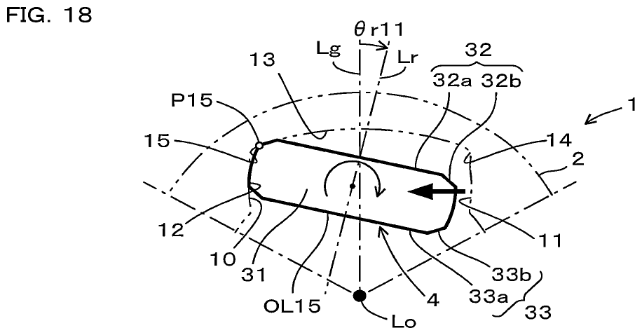

The groove-orthogonal sectional shape of a ceiling surface 13 of a tripod type constant velocity universal joint 1 of a third embodiment will be described with reference to FIGS. 18 to 20. In the third embodiment, for ease of the description, the difference between the facing distance between the first raceway surface 11 and the second raceway surface 12 and the width of the roller outer circumferential surface 31 is exaggerated in FIGS. 18 to 20 as in the second embodiment.

As shown in FIG. 18, a contour line OL15 obtained by projecting the roller 4 in the axial direction of the outer ring 2 when the joint angle is 0°, the roller 4 rolls in the positive direction by the predetermined rolling angle θr11, and the roller outer circumferential surface 31 comes into contact with the second raceway surface 12 and has a clearance from the first raceway surface 11 has a shape indicated by a wide continuous line. Therefore, the contour line OL15 is formed by the roller outer circumferential surface 31, the roller end face 32, and the roller base surface 33. A boundary point on the contour line OL15 between the roller outer circumferential surface 31 and the roller end face 32 that is located away from the central axis Lo of the outer ring 2 is defined as a positive rotation transmitting edge highest point P15.

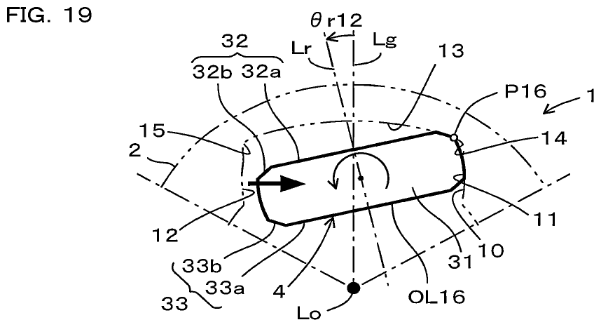

As shown in FIG. 19, a contour line OL16 obtained by projecting the roller 4 in the axial direction of the outer ring 2 when the joint angle is 0°, the roller 4 rolls in the negative direction by the predetermined rolling angle θr12, and the roller outer circumferential surface 31 comes into contact with the first raceway surface 11 and has a clearance from the second raceway surface 12 has a shape indicated by a wide continuous line. Therefore, the contour line OL16 is formed by the roller outer circumferential surface 31, the roller end face 32, and the roller base surface 33. A boundary point on the contour line OL16 between the roller outer circumferential surface 31 and the roller end face 32 that is located away from the central axis Lo of the outer ring 2 is defined as a negative rotation transmitting edge highest point P16.

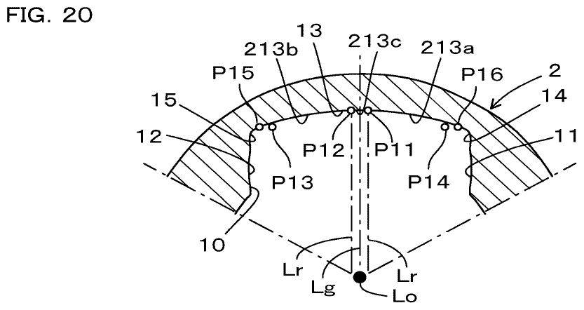

As shown in FIG. 20, the groove-orthogonal sectional shape of the ceiling surface 13 is a line shape passing through the first central highest point P11, the second central highest point P12, the positive rotation transmitting edge highest point P15, and the negative rotation transmitting edge highest point P16. Specifically, the groove-orthogonal sectional shape of the ceiling surface 13 is defined by a curved shape 213a connecting the first central highest point P11 and the negative rotation transmitting edge highest point P16, a curved shape 213b connecting the second central highest point P12 and the positive rotation transmitting edge highest point P15, and a straight shape 213c connecting the first central highest point P11 and the second central highest point P12. Each of the curved shapes 213a, 213b may be defined by an ellipse or a circular arc. In the present embodiment, the positive rotation back side edge highest point P13 and the negative rotation back side edge highest point P14 are not used.

The state shown in FIG. 18 can occur when the direction of the torque applied to the outer ring 2 and the tripod 3 is reversed in the state shown in FIG. 16. The state shown in FIG. 19 can occur when the direction of the torque applied to the outer ring 2 and the tripod 3 is reversed in the state shown in FIG. 17. The groove-orthogonal sectional shape of the ceiling surface 13 is set in consideration of such cases. Thus, it is possible to reduce the size and weight of the outer ring 2 in consideration of the clearance.

### Fourth Embodiment

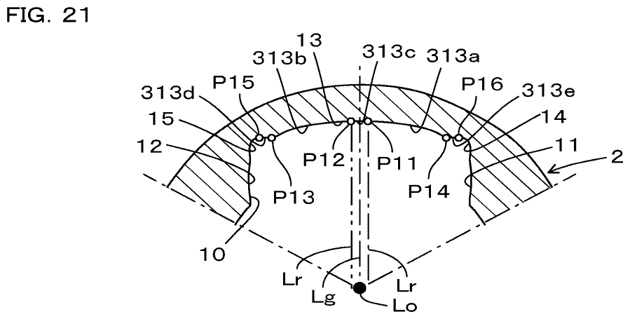

The groove-orthogonal sectional shape of a ceiling surface 13 of a tripod type constant velocity universal joint 1 of a fourth embodiment will be described with reference to FIG. 21. In the fourth embodiment, for ease of the description, the difference between the facing distance between the first raceway surface 11 and the second raceway surface 12 and the width of the roller outer circumferential surface 31 is exaggerated in FIG. 21 as in the second and third embodiments.

As shown in FIG. 21, the groove-orthogonal sectional shape of the ceiling surface 13 is a line shape passing through the first central highest point P11, the second central highest point P12, the positive rotation back side edge highest point P13, the negative rotation back side edge highest point P14, the positive rotation transmitting edge highest point P15, and the negative rotation transmitting edge highest point P16.

Specifically, the groove-orthogonal sectional shape of the ceiling surface 13 is defined by a curved shape 313a connecting the first central highest point P11 and the negative rotation back side edge highest point P14, a curved shape 313b connecting the second central highest point P12 and the positive rotation back side edge highest point P13, and a straight shape 313c connecting the first central highest point P11 and the second central highest point P12. Further, the groove-orthogonal sectional shape of the ceiling surface 13 is defined by a curved shape 313d connecting the positive rotation back side edge highest point P13 and the positive rotation transmitting edge highest point P15, and a curved shape 313e connecting the negative rotation back side edge highest point P14 and the negative rotation transmitting edge highest point P16. Each of the curved shapes 313a, 313b may be defined by an ellipse or a circular arc. According to the present embodiment, it is possible to reduce the size and weight of the outer ring 2 in consideration of the clearance.

1. A tripod type constant velocity universal joint comprising:
an outer ring having a plurality of raceway grooves extending in an axial direction;
a tripod including a plurality of tripod shaft portions extending radially outward; and
rollers externally fitted onto the tripod shaft portions and configured to roll in the raceway grooves, wherein:
the raceway groove includes a first raceway surface constituting one groove side surface, a second raceway surface constituting another groove side surface, and a ceiling surface constituting a groove bottom surface;
the roller includes
a roller outer circumferential surface configured to roll on the first raceway surface or the second raceway surface, and
a roller end face that is an axial end face of the roller that faces the ceiling surface;
a point located on a central axis of the roller and distant from a central axis of the outer ring on a contour line obtained by projecting the roller end face in the axial direction of the outer ring when the roller pitches by a predetermined pitching angle is defined as a central highest point;
a boundary point between the roller outer circumferential surface and the roller end face that is located away from the central axis of the outer ring on a contour line obtained by projecting the roller in the axial direction of the outer ring when the roller rolls in a positive direction by a predetermined rolling angle is defined as a positive rotation edge highest point;
a boundary point between the roller outer circumferential surface and the roller end face that is located away from the central axis of the outer ring on a contour line obtained by projecting the roller in the axial direction of the outer ring when the roller rolls in a negative direction by a predetermined rolling angle is defined as a negative rotation edge highest point; and
a groove-orthogonal sectional shape of the ceiling surface is a line shape passing through the central highest point, the positive rotation edge highest point, and the negative rotation edge highest point.

2. The tripod type constant velocity universal joint according to claim 1, wherein the groove-orthogonal sectional shape of the ceiling surface is defined by a curved shape connecting the central highest point and the positive rotation edge highest point, and a curved shape connecting the central highest point and the negative rotation edge highest point.

3. The tripod type constant velocity universal joint according to claim 1, wherein:
the central highest point includes
a first central highest point that is a point located on the central axis of the roller and distant from the central axis of the outer ring on a contour line obtained by projecting the roller end face in the axial direction of the outer ring when the roller pitches by the predetermined pitching angle and the roller outer circumferential surface comes into contact with the first raceway surface and has a clearance from the second raceway surface, and
a second central highest point that is a point located on the central axis of the roller and distant from the central axis of the outer ring on a contour line obtained by projecting the roller end face in the axial direction of the outer ring when the roller pitches by the predetermined pitching angle and the roller outer circumferential surface comes into contact with the second raceway surface and has a clearance from the first raceway surface;
the positive rotation edge highest point includes a positive rotation back side edge highest point that is a boundary point between the roller outer circumferential surface on a second raceway surface side and the roller end face and is located away from the central axis of the outer ring on a contour line obtained by projecting the roller in the axial direction of the outer ring when the roller rolls in the positive direction by the predetermined rolling angle and the roller outer circumferential surface comes into contact with the first raceway surface and has the clearance from the second raceway surface;
the negative rotation edge highest point includes a negative rotation back side edge highest point that is a boundary point between the roller outer circumferential surface on a first raceway surface side and the roller end face and is located away from the central axis of the outer ring on a contour line obtained by projecting the roller in the axial direction of the outer ring when the roller rolls in the negative direction by the predetermined rolling angle and the roller outer circumferential surface comes into contact with the second raceway surface and has the clearance from the first raceway surface; and
the groove-orthogonal sectional shape of the ceiling surface is a line shape passing through the first central highest point, the second central highest point, the positive rotation back side edge highest point, and the negative rotation back side edge highest point.

4. The tripod type constant velocity universal joint according to claim 3, wherein the groove-orthogonal sectional shape of the ceiling surface is defined by:
a curved shape connecting the first central highest point and the negative rotation back side edge highest point;
a curved shape connecting the second central highest point and the positive rotation back side edge highest point; and
a straight shape connecting the first central highest point and the second central highest point.

5. The tripod type constant velocity universal joint according to claim 1, wherein:
the central highest point includes
a first central highest point that is a point located on the central axis of the roller and distant from the central axis of the outer ring on a contour line obtained by projecting the roller end face in the axial direction of the outer ring when the roller pitches by the predetermined pitching angle and the roller outer circumferential surface comes into contact with the first raceway surface and has a clearance from the second raceway surface, and
a second central highest point that is a point located on the central axis of the roller and distant from the central axis of the outer ring on a contour line obtained by projecting the roller end face in the axial direction of the outer ring when the roller pitches by the predetermined pitching angle and the roller outer circumferential surface comes into contact with the second raceway surface and has a clearance from the first raceway surface;
the positive rotation edge highest point includes a positive rotation transmitting edge highest point that is a boundary point between the roller outer circumferential surface on a second raceway surface side and the roller end face and is located away from the central axis of the outer ring on a contour line obtained by projecting the roller in the axial direction of the outer ring when the roller rolls in the positive direction by the predetermined rolling angle and the roller outer circumferential surface comes into contact with the second raceway surface and has the clearance from the first raceway surface;
the negative rotation edge highest point includes a negative rotation transmitting edge highest point that is a boundary point between the roller outer circumferential surface on a first raceway surface side and the roller end face and is located away from the central axis of the outer ring on a contour line obtained by projecting the roller in the axial direction of the outer ring when the roller rolls in the negative direction by the predetermined rolling angle and the roller outer circumferential surface comes into contact with the first raceway surface and has the clearance from the second raceway surface; and
the groove-orthogonal sectional shape of the ceiling surface is a line shape passing through the first central highest point, the second central highest point, the positive rotation transmitting edge highest point, and the negative rotation transmitting edge highest point.

6. The tripod type constant velocity universal joint according to claim 5, wherein the groove-orthogonal sectional shape of the ceiling surface is defined by:
a curved shape connecting the first central highest point and the negative rotation transmitting edge highest point;
a curved shape connecting the second central highest point and the positive rotation transmitting edge highest point; and
a straight shape connecting the first central highest point and the second central highest point.

7. The tripod type constant velocity universal joint according to claim 3, wherein:
the positive rotation edge highest point further includes a positive rotation transmitting edge highest point that is a boundary point between the roller outer circumferential surface on the second raceway surface side and the roller end face and is located away from the central axis of the outer ring on a contour line obtained by projecting the roller in the axial direction of the outer ring when the roller rolls in the positive direction by the predetermined rolling angle and the roller outer circumferential surface comes into contact with the second raceway surface and has the clearance from the first raceway surface;
the negative rotation edge highest point further includes a negative rotation transmitting edge highest point that is a boundary point between the roller outer circumferential surface on the first raceway surface side and the roller end face and is located away from the central axis of the outer ring on a contour line obtained by projecting the roller in the axial direction of the outer ring when the roller rolls in the negative direction by the predetermined rolling angle and the roller outer circumferential surface comes into contact with the first raceway surface and has the clearance from the second raceway surface; and
the groove-orthogonal sectional shape of the ceiling surface is a line shape passing through the first central highest point, the second central highest point, the positive rotation back side edge highest point, the negative rotation back side edge highest point, the positive rotation transmitting edge highest point, and the negative rotation transmitting edge highest point.

8. The tripod type constant velocity universal joint according to claim 7, wherein the groove-orthogonal sectional shape of the ceiling surface is defined by:
a curved shape connecting the first central highest point and the negative rotation back side edge highest point;
a curved shape connecting the second central highest point and the positive rotation back side edge highest point;
a straight shape connecting the first central highest point and the second central highest point;
a line shape connecting the negative rotation back side edge highest point and the negative rotation transmitting edge highest point; and
a line shape connecting the positive rotation back side edge highest point and the positive rotation transmitting edge highest point.

9. The tripod type constant velocity universal joint according to claim 1, wherein:
the predetermined pitching angle is an angle larger than a maximum joint angle of the tripod type constant velocity universal joint during straightforward traveling of a vehicle at a constant speed; and
the predetermined rolling angle is an angle larger than a maximum rolling angle of the roller during the straightforward traveling of the vehicle at the constant speed.

10. The tripod type constant velocity universal joint according to claim 9, wherein:
the maximum joint angle of the tripod type constant velocity universal joint during the straightforward traveling of the vehicle at the constant speed is an angle included in a range of 4 to 10°; and
the maximum rolling angle of the roller during the straightforward traveling of the vehicle at the constant speed is an angle included in a range of 0 to 5°.

11. The tripod type constant velocity universal joint according to claim 9, wherein:
the predetermined pitching angle is an angle larger than a maximum joint angle of the tripod type constant velocity universal joint during acceleration or deceleration of the vehicle traveling straightforward; and
the predetermined rolling angle is an angle larger than a maximum rolling angle of the roller during the acceleration or deceleration of the vehicle traveling straightforward.

12. The tripod type constant velocity universal joint according to claim 9, wherein:
the predetermined pitching angle is an angle equal to or smaller than a maximum joint angle of the tripod type constant velocity universal joint during acceleration or deceleration of the vehicle traveling straightforward; and
the predetermined rolling angle is an angle equal to or smaller than a maximum rolling angle of the roller during the acceleration or deceleration of the vehicle traveling straightforward.

13. The tripod type constant velocity universal joint according to claim 11, wherein:
the maximum joint angle of the tripod type constant velocity universal joint during the acceleration or deceleration of the vehicle traveling straightforward is an angle included in a range of 6 to 20°; and
the maximum rolling angle of the roller during the acceleration or deceleration of the vehicle traveling straightforward is an angle included in a range of 0 to 5°.

14. The tripod type constant velocity universal joint according to claim 1, wherein:
the predetermined pitching angle is an angle smaller than a maximum joint angle of the tripod type constant velocity universal joint during maximum steering; and
the predetermined rolling angle is an angle smaller than a maximum rolling angle of the roller during the maximum steering.

15. The tripod type constant velocity universal joint according to claim 14, wherein:
the maximum joint angle of the tripod type constant velocity universal joint during the maximum steering is an angle included in a range of 10 to 25°; and
the maximum rolling angle of the roller during the maximum steering is an angle included in a range of 0 to 10°.

16. The tripod type constant velocity universal joint according to claim 1, wherein the roller is externally fitted onto the tripod shaft portion so that the roller is tiltable relative to the tripod shaft portion.

17. The tripod type constant velocity universal joint according to claim 12, wherein:
the maximum joint angle of the tripod type constant velocity universal joint during the acceleration or deceleration of the vehicle traveling straightforward is an angle included in a range of 6 to 20°; and
the maximum rolling angle of the roller during the acceleration or deceleration of the vehicle traveling straightforward is an angle included in a range of 0 to 5°.
